(19) United States
(12) Patent Application Publication
(10) Pub. No.: US 2007/0119639 A1
(43) Pub. Date: May 31, 2007

(54) Secondary power system for automobiles

(76) Inventors: Ernesto G. Villagrana, Nogales, AZ (US); Ernesto A. Villagrana, Nogales, AZ (US)

Correspondence Address: SUNG I. OH, PROFESSIONAL LAW CORPORATION, 710 QUAIL VALLEY LANE, WEST COVINA, CA, 91791, US

(21) Appl. No.: 11/500,780

(22) Filed: Aug. 8, 2006

Related U.S. Application Data
(60) Provisional application No. 60/740,194, filed on Nov. 28, 2005.

(51) Int. Cl. B60K 6/00; F02N 15/06; F02N 11/00

(52) U.S. Cl. 180/65.2; 74/6; 123/179.25

(57) ABSTRACT

An engine system for a motor vehicle combines a battery-powered system with an internal combustion system so that, at low speeds, the battery-powered system is used to drive the vehicle while at high speeds the internal combustion engine drives the vehicle. The battery-powered system includes a flywheel.

### TECHNICAL FIELD OF THE INVENTION

The present invention relates to power systems for driving motor vehicles and more particularly to a power system which utilizes an electric motor and flywheel combination.

### BACKGROUND OF THE INVENTION

The most widely used form of transportation in the world today is based on the use of internal combustion engines as the prime mover of ground transportation vehicles. Such engines are controlled by a throttle which varies the amount of fuel and air metered to the engine typically through a carburetor. The nature of the internal combustion engine fuel-burning process is such that products of incomplete combustion are generally admitted to the air. In addition to this basic engine problem, engine throttling is an inherently inefficient process, particularly at light load. Quick engine power response requires fuel-air mixture enrichment, thus adding to unburnt product emissions. All of these factors are particularly important in large cities where start-and-stop driving is common and where pollution is of major concern.

An interest in hybrid power systems has arisen primarily because of the increasing cost of fuel and the inefficiency of operation of conventional internal combustion engine power systems for motor vehicles. When an internal combustion engine is the sole source of power for a motor vehicle, the engine must be of sufficient size and capacity to deliver maximum power loads on demand for acceleration, even though such demands are occasional and the normal operation is at a much lower power demand range. The engine could operate much more efficiently if it could operate substantially continuously within an optimum efficiency operating range without maintaining the capability of providing an output substantially greater than this range. Utilizing an engine requiring operation only in the optimum efficiency operating range would allow the use of a less powerful and a much lighter engine with the obvious attendant economy.

Electric motors have been developed as substitutes for internal combustion engines, but they have been found to be generally unacceptable for universal usage in motor vehicles because of the limited energy storage capacity of electric storage batteries in relation to weight limitations for efficient vehicle application and because of the extended time that batteries must be out of operation for recharging.

Flywheels have also been utilized in attempts to store kinetic energy that can be delivered during times of peak load demand so that an internal combustion engine or an electric motor need not have the size and capacity necessary for delivering sufficient power in themselves during periods of acceleration. Flywheels also have the advantage of receiving energy generated during braking of the vehicle so that such energy that is normally dissipated as heat and not reused can be regenerated in the flywheel for subsequent delivery during peak load demands during acceleration. However, flywheels have the disadvantage of a reduction in the output speed of rotation as the energy is being dissipated, which is usually during periods of vehicle acceleration when rotational speeds are increasing otherwise. Furthermore, most flywheels require operation of the internal combustion engine.

The systems known to the inventor require operation of the internal combustion engine at some speed to move the vehicle. However, there are times when the vehicle will operate most efficiently at very low speeds, such as when creeping in traffic, when moving on a slippery surface, such as ice or mud, when being parked or the like. Operation of an engine at such low speeds is inefficient and wasteful of gasoline.

There is a need for a motor vehicle which can move when the internal combustion motor is not activated so the motor vehicle can conserve gasoline as well as operate efficiently at low speeds.

### SUMMARY OF THE INVENTION

The above-discussed disadvantages of the prior art are overcome by an engine system for a motor vehicle which combines a battery-powered system with an internal combustion system so that, at low speeds, the battery-powered system is used to drive the vehicle while at high speeds the internal combustion engine drives the vehicle. The battery-powered system includes a flywheel.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a schematic showing a front wheel drive combined battery-powered/internal combustion engine embodying the present invention.

FIG. 2 is a schematic showing a detail of the schematic of FIG. 1.

FIG. 3 is a schematic showing a rear wheel drive combined battery-powered/internal combustion engine embodying the present invention.

FIG. 4 is a schematic showing a detail of the schematic of FIG. 3.

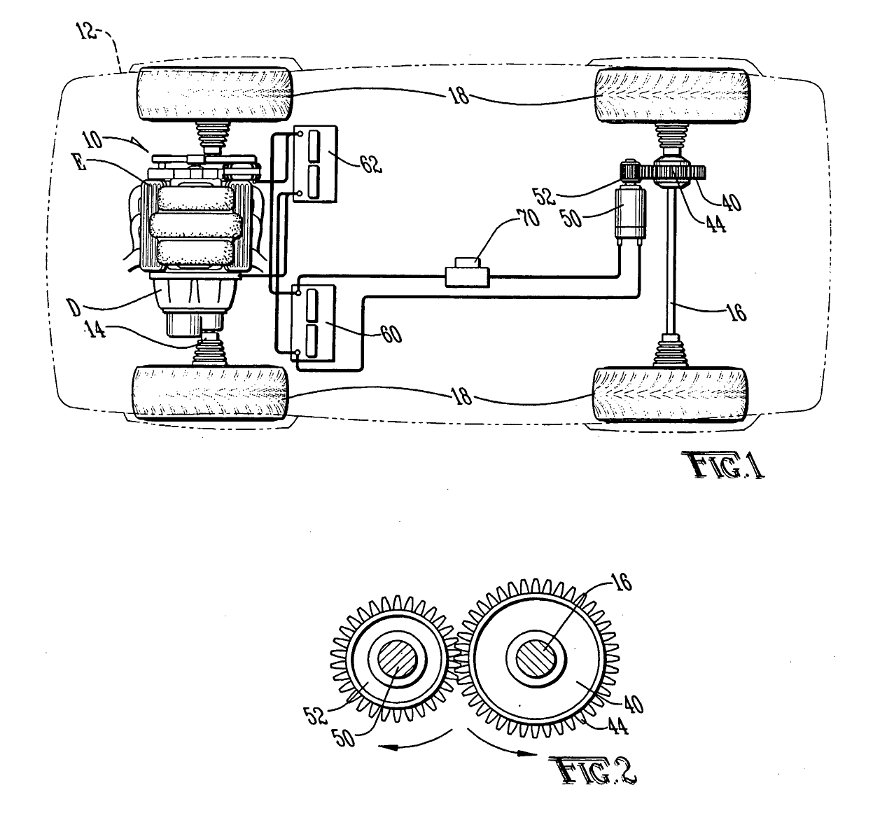

### DETAILED DESCRIPTION OF THE INVENTION

Referring to the figures, it can be understood that the present invention is embodied in a combined battery-powered/internal combustion engine 10. System 10 comprises a motor vehicle 12 having a first axle 14 which is a front axle when the motor vehicle is in use and a second axle 16 when the motor vehicle is in use. Vehicle tires 18 are mounted on the axles.

A drive shaft 30 has a first end 32 which is a front end when the drive shaft is in use and a second end 34 which is a rear end when the drive shaft is in us. The drive shaft extends between the front axle and the rear axle of the motor vehicle. A flywheel 40 is connected to the front axle of the motor vehicle for rotation therewith. Flywheel 40 includes a multiplicity of gear teeth 44 thereon.

A starter motor 50 is mounted on the drive shaft and includes a drive gear 52 operably connected thereto to be driven by the starter motor when the starter motor is activated. Drive gear 52 includes a multiplicity of gear teeth that operably engage the gear teeth on the flywheel to drive the flywheel when the starter motor is activated.

A power source 60, such as a battery, is mounted on the drive shaft. The battery can be the battery of the motor vehicle or connected to battery 62 of the motor vehicle. A switch 70 is electrically interposed between the starter motor and the power source and electrically connects the power source to the starter motor to activate the starter motor when the switch is in an “on” position.

When the starter is activated, front axle 14 is rotated by the battery-powered system whereby engine E of the motor vehicle need not be engaged, thereby saving fuel for those situations, such as vehicle creeping, when vehicle speed is so low that it will be inefficient to operate the vehicle using engine E.

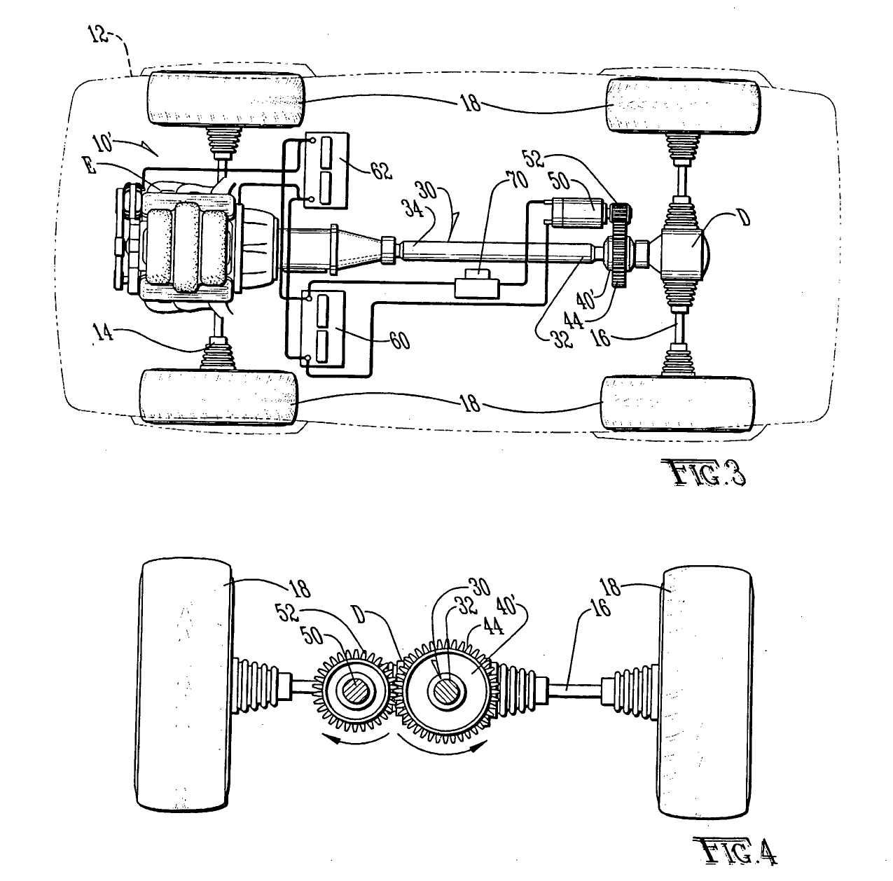

A second form of the combined battery-powered/internal combustion engine of the present invention is shown in FIGS. 3 and 4 as system 10′ in which flywheel 40′ is connected to rear axle 16 of the motor vehicle for rotation therewith. Flywheel 40′ can be located adjacent to differential D of the motor vehicle on the rear axle of the motor vehicle, and can be oriented to be perpendicular to the gear of the starter motor.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A combined battery-powered/internal combustion engine comprising:
A) a motor vehicle having a first axle which is a front axle when the motor vehicle is in use and a second axle when the motor vehicle is in use;
B) vehicle tires mounted on the axles;
C) a drive shaft having
(1) a first end which is a front end when the drive shaft is in use,
(2) a second end which is a rear end when the drive shaft is in use, and
(3) the drive shaft extending between the front axle and the rear axle of the motor vehicle;
D) a flywheel connected to the front axle of the motor vehicle for rotation therewith, the flywheel including a multiplicity of gear teeth thereon;
E) a starter motor mounted on the drive shaft and including a drive gear operably connected thereto to be driven by the starter motor when the starter motor is activated, the drive gear including a multiplicity of gear teeth that operably engage the gear teeth on the flywheel to drive the flywheel when the starter motor is activated;
F) a power source mounted on the drive shaft;
G) a switch electrically interposed between the starter motor and the power source and electrically connecting the power source to the starter motor to activate the starter motor when the switch is in an “on” position.

2. A combined battery-powered/internal combustion engine comprising:
A) a motor vehicle having a first axle which is a front axle when the motor vehicle is in use and a second axle when the motor vehicle is in use;
B) vehicle tires mounted on the axles;
C) a drive shaft having
(1) a first end which is a front end when the drive shaft is in use,
(2) a second end which is a rear end when the drive shaft is in use, and
(3) the drive shaft extending between the front axle and the rear axle of the motor vehicle;
D) a flywheel connected to the rear axle of the motor vehicle for rotation therewith, the flywheel including a multiplicity of gear teeth thereon;
E) a starter motor mounted on the drive shaft and including a drive gear operably connected thereto to be driven by the starter motor when the starter motor is activated, the drive gear including a multiplicity of gear teeth that operably engage the gear teeth on the flywheel to drive the flywheel when the starter motor is activated;
F) a power source mounted on the drive shaft;
G) a switch electrically interposed between the starter motor and the power source and electrically connecting the power source to the starter motor to activate the starter motor when the switch is in an “on” position.

3. The combined battery-powered/internal combustion engine defined in claim 2 wherein the motor vehicle further includes a battery and the power source is connected to the battery.

4. The combined battery-powered/internal combustion engine defined in claim 2 wherein the motor vehicle further includes a differential system on the rear axle and the flywheel is located adjacent to the differential system on the rear axle.

5. The combined battery-powered/internal combustion engine defined in claim 4 wherein the flywheel is oriented to be perpendicular to the drive gear on the starter motor.
